(19) United States
(12) Patent Application Publication
(10) Pub. No.: US 2002/0057817 A1
(43) Pub. Date: May 16, 2002

(54) Hearing aid

(75) Inventor: Alexander L. Darbut, Edina, MN (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Resistance Technology, Inc., Arden Hills, MN

(21) Appl. No.: 09/974,732

(22) Filed: Oct. 9, 2001

Related U.S. Application Data
(60) Provisional application No. 60/239,055, filed on Oct. 10, 2000.

(51) Int. Cl. H04R 9/08; H04R 11/04; H04R 17/02; H04R 19/04; H04R 21/02

(52) U.S. Cl. 381/355; 381/361

(57) ABSTRACT

An acoustic microphone configuration includes first and second acoustic microphones, each microphone having a port, the ports being spaced apart from each other a selected distance and being disposed along substantially the same plane.

### CROSS-REFERENCE TO RELATED APPLICATION(S)

Applicant claims the priority date of U.S. Provisional Application 60/239,055, filed Oct. 10, 2000.

### BACKGROUND OF THE INVENTION

The present invention relates to hearing aids, and in particular, it relates to the use of multiple microphones and a positioning of such microphones.

Gennum Corporation of Canada markets a directional hearing system sold under the trademark FrontWave™ that utilizes two omni-directional microphones that are spaced between 6 to 13 mm. The FrontWave™ system has limited directivity performance due to the limited physical microphone port spacing. The FrontWave™ system can be programmed to vary the polar response from hypercardiod, supercardiod and cardiod with limited hearing benefits imposed mainly by the physical port spacing. The directivity pattern generated by the two microphones is a function of the ratio of the internal electronic delay between the ports.

Other arrangements include microphone arrays or multiple microphones that are positioned on eyeglass frames and the head, or on a body worn vest to improve the physical spacing between the microphones. However, these systems have cosmetic and conveniency limitations for the user.

### BRIEF SUMMARY OF THE INVENTION

The present invention includes an arrangement for positioning miniature acoustic microphones wherein the ports of each microphone are positioned along the same plane and are spaced from each a selected distance.

### BRIEF DESCRIPTION OF THE DRAWINGS

FIG. 1 is a perspective view of the present invention.

FIG. 2 is a perspective view of an in-the-ear configuration of the present invention.

FIG. 3 is a perspective view of a behind-the-ear and in-the-ear configuration of the present invention.

FIG. 4 is a plan view of the present invention.

FIG. 5 is a perspective view of the present invention.

FIG. 6 is a front view of the present invention.

FIG. 7 is an exploded perspective view of the present invention.

### DETAILED DESCRIPTION

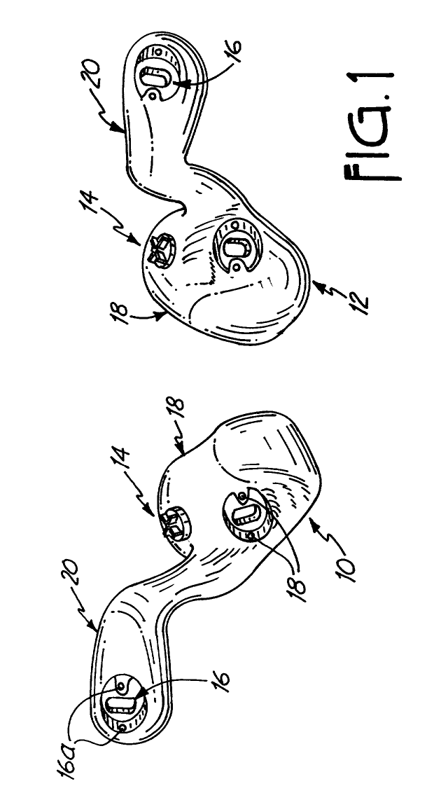

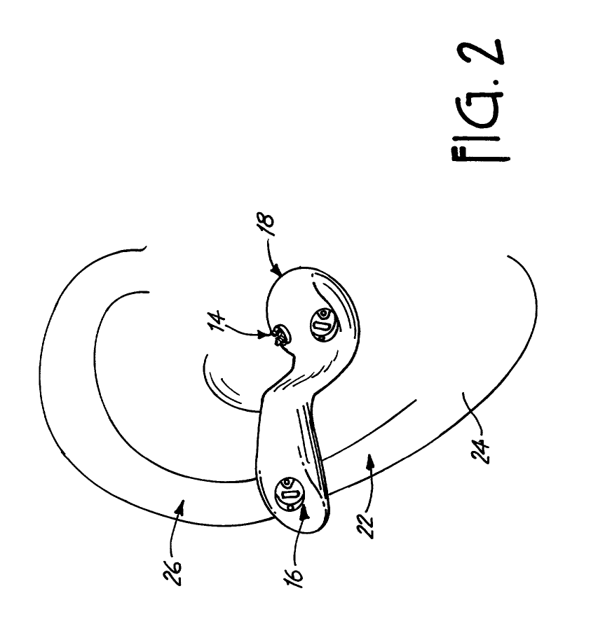

The present invention is generally indicated by 10 and 12 in FIG. 1. In-the-ear/in-the-canal hearing aids 10 and 12, each have two unidirectional microphones 14 and 16. The one unidirectional microphone 14 is located on a main body 18 of the hearing aid which is situated in the ear, as illustrated in FIG. 2. The other unidirectional microphone 16 is located on a boom that extends from the main body 18 and is disposed along the outer ear 22 above the lobe 24 at a lower portion of the helix 26. Like reference characters will be used to indicate like elements throughout the drawings.

The ports 17 and 19 of the two unidirectional microphones are spaced apart to provide enhanced beam forming capabilities which result from increasing the spacing between the microphone ports. An example of a suitable microphone includes Resistance Technology's (the assignee of the present application) Intellimic™ microphone In the configuration shown in the Figures, the microphone ports are typically spaced between 6 to 13 mm. A distance of 30 to 35 mm is ideal. Such a design balances ergometric and acoustical properties. Ideally, spacing between ports should be between 6 inches or 8 inches to provide maximum low frequency detection below 2 KHz.

With the two microphone ports spaced at 30 mm, performance above 5 dB is improved and such spacing makes it possible to use digital signal processing (DSP) to steer the acoustical beam and make it adaptable to changing noisy environments.

Key features of the invention include either two omni-directional or two unidirectional microphones. Two directional microphones give higher performance results.

The microphone ports are preferably disposed on the same plane and aligned in the same direction (along parallel axes).

With DSP, this invention has an adaptive beam forming system in contrast to the fixed beam systems that are used presently.

An alternative embodiment of the present invention includes an in-the-ear and a behind-the-ear configuration generally indicated at 50 in FIG. 3. The in-the-ear component is referenced at 52 while the behind-the-ear component is referenced at 54. The components 52 and 54 are connected through a flex coil connection 56 that is coated. Component 52 contains an in-the-ear directional microphone 58 and component 54 contains a behind-the-ear directional microphone 60, respectively. The ports of each microphone 58 and 60 are disposed in the same plane and aligned along parallel axes. Preferably, the microphone 60 in the behind-the-ear component 54 is positioned on the lower front side of the component 54 that is closest to the earlobe 24.

In one embodiment, all of the electronics of the hearing aid are moved into the behind-the-ear component 54 so that in-the-ear component 52 can be made very small with only a microphone 58 and receiver (not shown) for improved fitting geometry.

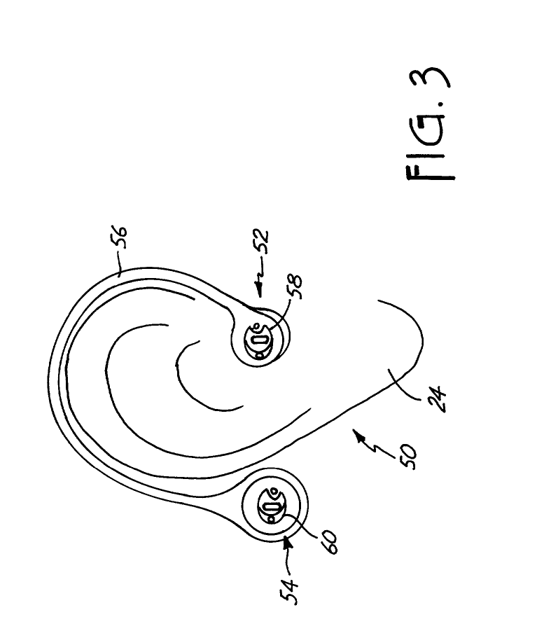

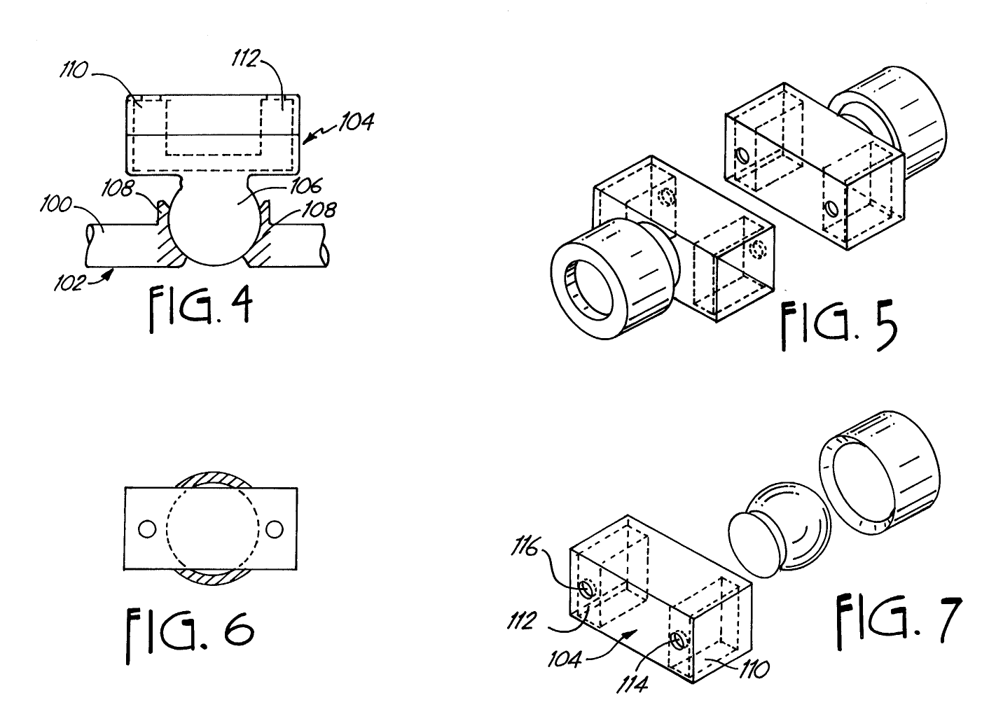

FIGS. 4 through 7 illustrate a faceplate 100 of an in-the-ear hearing aid 102 having a beam forming array body 104 secured to the faceplate 100 by a ball 106 and a socket 108 assembly. The beam forming array body 104 includes a pair of spaced apart microphones 110 and 112 with corresponding spaced apart microphone ports 114 and 116.

The beam forming array body 104 is rotatable through the ball 106 and socket 106 and 108. Two omni-directional microphones are positioned within the beam forming array body 104, however, directional microphones may also be used. Wiring or electrical contacts are not shown in FIGS. 4 through 7.

The beam forming array body 104 is detachably removable from the faceplate 100. The ball and socket 106, 108 arrangement permits the beam forming array body 104 to be snapped into connection with the faceplate 100. One advantage of the beam forming array body 104 is that the component portion of the hearing aid that is below the faceplate 100 and is disposed within the ear is standardized. Thereby, microphone changes can be made in the beam forming array body 104 for customization without having to customize the components of that portion of the hearing aid disposed within the ear.

Another advantage of the beam forming array body 104 is that since both microphones are in the array, which is positioned away from the components below the faceplate 100, acoustical feedback is eliminated from the hearing aid. Typically, the microphones are attached to the inside, below the faceplate 100, of the in-the-ear portion of the hearing aid.

Another advantage of the beam forming array body 104 is that both microphones are disposed in the same plane and along parallel axes which improves directivity pickup by the microphones.

The ball and socket 106, 108, construction requires strength and integrity to hold the beam forming array body 104 in position. The ball and socket 106, 108 can be made smaller than illustrated in FIGS. 4 through 7, and may be made of titanium or other metals that permit the ball and socket arrangement 106, 108 to be very small while very strong.

Although the present invention has been described with reference to preferred embodiments, workers skilled in the art will recognize that changes may be made in form and detail without departing from the spirit and scope of the invention.

1. A miniature microphone arrangement comprising:
a first miniature microphone having a first acoustic port; and
a second miniature microphone having a second acoustic port; and
wherein the first and second acoustic ports are spaced apart from each other a selected distance and disposed in substantially the same plane.
